(19) United States
(12) Patent Application Publication
(10) Pub. No.: US 2023/0196076 A1
(43) Pub. Date: Jun. 22, 2023

(54) METHOD FOR OPTIMALLY SELECTING FLOOD-CONTROL OPERATION SCHEME BASED ON TEMPORAL CONVOLUTIONAL NETWORK

(71) Applicant: HOHAI UNIVERSITY, Nanjing (CN)

(72) Inventors: Hexuan HU, Nanjing (CN); Qiang HU, Nanjing (CN); Ye ZHANG, Nanjing (CN); Zhenyun HU, Nanjing (CN)

(21) Appl. No.: 17/909,003

(22) PCT Filed: Nov. 5, 2021
(86) PCT No.: PCT/CN2021/128854

§ 371 Date: Sep. 2, 2022

(30) Foreign Application Priority Data
Mar. 15, 2021 (CN) 202110289848.0

(51) Int. Cl. G06N 3/0464; G06N 3/048; G06N 3/084; G06N 3/049

(52) U.S. Cl. CPC G06N 3/0464; G06N 3/048; G06N 3/084; G06N 3/049

(57) ABSTRACT

A method for optimally selecting a flood-control operation scheme based on a temporal convolutional network. The method includes evaluating the flood-control operation schemes in a group of reservoirs; a time-sequence evaluating indicator matrix combining the comprehensive evaluation indicators and the time sequence, which serves as an input of the temporal convolutional network, is constructed to calculate comprehensive scores for training samples of the flood-control operation schemes based on a fuzzy set theory and an improved entropy weight method; a structure of the temporal convolutional network is determined; the temporal convolutional network is trained by adopting a loss function combining a mean square error and a Nash efficiency coefficient; and the time-sequence evaluating indicator matrix for the flood-control operation schemes is input into the temporal convolutional network to obtain the comprehensive evaluation values for the schemes, and an optimal comprehensive evaluation value is taken as an optimal flood-control operation scheme.

### TECHNICAL FIELD

The present disclosure belongs to the technical field of flood-control operation in reservoirs, and relates to a method for optimally selecting a flood-control operation scheme based on a temporal convolutional network.

### BACKGROUND

Flood-control operation for a group of reservoirs has a high practicality, which is affected by many factors such as operation objectives, water inflow conditions, and the knowledge and experience of the operator, and is closely related to various factors such as society, economy, nature, ecology. Therefore, the evaluation of the flood-control operation scheme for the group of reservoirs is an indicator evaluation model with a plurality of objectives, a plurality of attributes, and a plurality of levels. The flood-control operation in real time is further a process of an irreversible real-time dynamic correction. For such a model with a plurality of indicators, its evaluation has the characteristics such as too many levels of influencing factors, complex configuration of the indicator system, and difficulty in quantifying too many qualitative indicators. Thus, it is of great theoretical significance and practical value to comprehensively and thoroughly consider a variety of influencing factors, and to formulate a reasonable system for evaluating indicators, so as to optimally select an optimal scheme of the flood-control operation for the group of reservoirs.

With respect to the problem of optimally selecting a flood-control operation scheme, multi-sCheme comparison and selection methods are widely used, such as expert-system evaluation method, grey-relation decision-making method, projection pursuit method, fuzzy comprehensive evaluation method, analytic hierarchy process (ahp) and pros and cons Solution (Topsis), and the like.

The above methods are highly subjective and affected by the correlation of indicators, require experts to provide the weights of different indicators, which will not change with the change of the flood control situation, and fail to fully consider the time change during the process of optimally selecting the scheme, Most of the methods only take a single reservoir as the research target, and its effectiveness-risk decision indicators lack of evaluating the expected loss that may be caused after the occurrence of risks (water level or flow exceeds the safety threshold) at the reservoir or the flood control point. To the end, it's not possible for the existing methods to accurately make a decision and selection from many feasible operation schemes. How to perform, under the influence of multiple uncertainties, a comprehensive and multi-aspect intelligent selection from the schemes of joint flood-control operation for large-scale groups of reservoirs in basin is a technical problem that needs to be solved urgently.

### SUMMARY

The objectives of the present disclosure are to overcome the defects of the prior art, and to provide a method for optimally selecting a flood-control operation scheme based on a temporal convolutional network, which can perform a comprehensive and multi-aspect intelligent selection from the schemes for joint flood-control operation in a large-scale group of reservoirs in the basin.

In order to solve the above-mentioned technical problems, the following technical solutions are adopted in the present disclosure.

A method for optimally selecting a flood-control operation scheme based on a temporal convolutional network is provided in the present disclosure. The method includes the following steps.

In Step 1, an evaluation indicator system for flood-control operation schemes of a group of reservoirs is established.

In Step 2, a time-sequence evaluating indicator matrix for the flood-control operation schemes is constructed, wherein the matrix sen'es as an input of the temporal convolutional network, comprehensive scores for training samples of the flood-control operation schemes are calculated based on a fuzzy set theory and an improved entropy weight method: a fuzzy decision matrix is established, relative membership degrees between quantitative and qualitative evaluation indicators are determined to obtain a matrix of the relative membership degrees, thereby constructing the time-sequence evaluating indicator matrix for the flood-control operation schemes; the matrix is taken as the input of the temporal convolutional network, and a calculation formula of entropy weights is improved with respect to different types of evaluation indicators; the comprehensive evaluation values for the flood-control operation schemes are calculated based on the fuzzy set theory and the improved entropy weight method, and the comprehensive evaluation values used to eventually determine pros and cons of the schemes are taken as outputs, wherein the comprehensive evaluation values are obtained by a. fuzzy comprehensive evaluation method; the training samples of the temporal convolutional network are expanded by adopting a supervised interpolation-based multi-sample data enhancement method SMOTE to generate new samples for the small sample type.

In Step 3, a structure of the temporal convolutional network is determined. The structure includes an inputting layer, a causal dilated convolution, an activation function, a residual connection, a fully connected layer arid an outputting layer.

In Step 4, the temporal convolutional network is trained by adopting a loss function that combines a mean square error and a Nash efficiency coefficient.

In Step 5, the time-sequence evaluating indicator matrix for the flood-control operation schemes is input into the temporal convolutional network to obtain the comprehensive evaluation values for the schemes, and an optimal comprehensive evaluation value is taken as an optimal flood-control operation scheme for the group of reservoirs.

Furthermore, Step 2 specifically includes the following steps.

In Step 2.1. weights of the evaluation indicators of reservoirs, flood storage and detention areas, and hydrology stations are set.

In Step 2.1.1, the evaluating indicator matrix X=(xᵢⱼ)_{l×q} is normalized to obtain a relative superiority-membership-degree matrix R=(rᵢⱼ)_{l×q}, rᵢⱼ∈[0,1],
where l represents evaluation indicators, q represents evaluation targets, i=1,2, . . . , q; j=1,2, . . . , l; and xᵢⱼ is an eigenvalue of an indicator j of a target i.

In Step 2,1.2, entropy weights ωₕⱼ of the evaluation indicators are calculated;

ωₕⱼ=Hₛωₕₛⱼ+(1−Hₛ)ωₕₖⱼ,

where ωₕₛⱼ, ωₕₖⱼ are weight coefficients of entropy value separation magnitudes, Hₛ is the same part, starting from the first digit after the decimal point, of entropy values in an entropy value vector, rᵢⱼ is a relative superiority-membership-degree value of an indicator j of a target i, Hⱼ is an entropy value corresponding to rᵢⱼ, eᵢⱼ is a relative importance degree of rᵢⱼ,

$${ω}_{hsj} = \frac{( 1 - {H}_{s} )}{{\sum }_{k = 1 , {H}_{k} \neq 1}^{m} ( 1 - {H}_{s} )} , {ω}_{hkj} = \frac{( 1 - {H}_{j} )}{{\sum }_{k = 1 , {H}_{k} \neq 1}^{m} ( 1 - {H}_{j} )} , \\ {H}_{j} = \frac{1}{lnn} {\sum }_{i = 1}^{n} {e}_{ij} {lne}_{ij} , \\ {e}_{ij} = \frac{{r}_{ij}}{{\sum }_{i = 1}^{n} {r}_{ij}} , \\ j = 1 , 2 , … , m .$$

In Step 2.2, weights of risk-and-effectiveness evaluation indicators are set.

In Step 2.2.1, a risk-effectiveness negotiation decision model for the flood-control operation is constructed.

It is asswned that the comprehensive risk-and-effectiveness evaluation indicators have a number of w+p in total, which includes w risk evaluation indicators and p effectiveness evaluation indicators, a risk set DM1 and an effectiveness set DM2 are formed through systematic evaluation indicators, and u1(x) and u2(x) are defined as utility gain functions for risk and effectiveness; and the utility gain functions are as follows:

u₁ⱼ(x)=Σᵢ₌₁^{w}ωᵢ×rⱼᵢ, u₂ⱼ(x)=Σᵢ₌₁^{p}ωᵢ×rⱼᵢ,

where ωᵢ is a weight of a risk or effectiveness evaluation indicator, and rⱼᵢ is a relative superiority-membership-degree value of a target i of an evaluation indicator j.

Thus, a problem of multi-attribute decision-making optimization is transformed into a problem of nonlinear programming; for the utility gain functions, they are capable of forming a two-dimensional curved surface in a space; for risk-and-effectiveness constraint conditions, they are capable of forming a plane in the space; it can be known according to the utility gain function and the risk-and-effectiveness constraint conditions that the target is to acquire a maximum value for the utility gain functions among the plane and curved surface nodes, which can be expressed as: max{F(x)=[u₁(x), u₂(x)]}.

In Step 2,2.2, the risk-and-effectiveness weights are calculated, wherein

a weight of a risk indicator is

$${ω}_{e} = \frac{{\sum }_{k = 1}^{l} {H}_{k} + 1}{{\sum }_{m = 1}^{l} ( {\sum }_{k = 1}^{l} 1 - 2 {H}_{k} )} ,$$

and

a weight of an effectiveness indicator is

$${ω}_{e}^{′} = \frac{{\sum }_{k = 1}^{l} 1 - 2 {H}_{k}}{{\sum }_{n = 1}^{l} ( {\sum }_{k = 1}^{l} {H}_{k} + 1 )} ,$$

where i=1,2, . . . , l, Σᵢ₌₁^{l}ω=1, and Hₖ is an entropy value for the evaluation indicator j.

In Step 2.3, a calculation of fuzzy comprehensive evaluation is performed.

A model for the fuzzy comprehensive evaluation is bⱼ=Σᵢ₌₁^{m}ω(i) rᵢⱼ, the schemes are sorted according to a principle of maximum membership degree, an optimal scheme is selected from the flood-control operation schemes, that is, Bₒₚₜ=max{bⱼ}; and the training samples for the temporal convolutional network are expressed as {Y, bⱼ|Y=(x_{ab})_{t×12}}, where Y is the time-sequence evaluating indicator matrix for the flood-control operation schemes, and a, b are sequence numbers of time and evaluation indicators respectively.

In Step 2.4, an eigenspace is defined, each sample is mapped to a certain point in the eigenspace, and a sampling ratio N is determined according to a sample imbalance ratio. K nearest neighbor samples are found according to an Euclidean distance for each sample (x, y) in a small sample type, and a sample point is randomly selected from the K nearest neighbor samples. It is assumed that the selected nearest neighbor point is (xₙ, yₙ), a point from a line segment between the sample point and the nearest neighbor sample point in the eigenspace is randomly selected as a new sample point, which satisfies the following formula:

(x_{new}, y_{new})=(x, y)+rand(0−1)*((xₙ−x), (yₙ−y)).

The above steps are repeated until the numbers of large and small samples are balanced.

Moreover, Step 3 includes the following steps.

A convolution kernel size of the causal convolution is set to be 3, a convolution kernel size of the dilated convolution is set to be 3 as well. Dilation factors are 1, 2, and 4 sequentially. A parameterized ReLU=max{ax, x} is adopted as an activation function, where 0<a<1. Two dilated causal convolution layers and two activation functions are present on a residual line respectively, 6 residual blocks are set to be stacked on the residual line. The dilation factors of the residual blocks from left to right are from 20 to 25. An output of the last residual block is connected to a fully connected layer with a sigmoid activation function.

Additionally, Step 4 further includes the following steps.

A loss function MSE′ that combines the mean square error and the Nash efficiency coefficient is constructed, and MSE′ is adopted to train the temporal convolutional network, which is expressed as:

$${MSE}^{′} ( y , {y}^{′} ) = \frac{{\sum }_{i = 1}^{n} {α ( {y}_{i} - {y}_{{i}^{′}} )}^{2}}{n} , α = 1 - \frac{{\sum }_{t = 1}^{T} {( {y}_{i} - {y}_{{i}^{′}} )}^{2}}{{\sum }_{t = 1}^{T} {( {y}_{i} - \overline{{y}_{i}} )}^{2}} ,$$

where yᵢ is an output value for a sample i, yᵢ′ is a target value for the sample i, y̅₁ is an average value of the output values for the sample i, α is a Nash correction parameter, and T is a time.

Values of the weights and the parameters are updated by a gradient descent method according to an obtained error to minimize an output error, and the training is ended when the number of training iterations satisfies the requirements, and the error is less than or equal to an expected value.

Compared with the prior art, the present disclosure has the following advantages and beneficial effects.

1. In the present disclosure, the temporal convolutional network is introduced to optimally select the flood-control operation scheme. An evaluating indicator system for the flood-control operation schemes of a group of reservoirs is established. A time-sequence evaluation indicator matrix for the flood-control operation schemes, which combines the comprehensive evaluation indicators and the time sequence, is constructed, and the matrix is input into the temporal convolutional network to obtain the comprehensive evaluation value for the schemes. The scheme with the optimal comprehensive evaluation value is taken as the optimal flood-control operation scheme for the group of the reservoirs. Generally, the constructed evaluating indicator system for the flood-control operation schemes is extremely huge, which increases the complexity of modeling for optimally selecting the scheme. Therefore, for the problem of optimally selecting the flood-control operation scheme of a large-scale group of reservoirs, the temporal convolutional network is used to optimally select the flood-control operation scheme according to the present disclosure, which can greatly reduce the number of parameters in the complex models, and better dig out the relationships between the evaluation indicators. Moreover, the process of optimally selecting the optimal flood-control operation scheme, fully considered under time variation, can improve the evaluation performance of the optimal selection of the model by using fine-tuning techniques adequately based on the idea of transfer learning.

2. In the present disclosure, with respect to different types of the evaluation indicators for the flood-control operation scheme, the characteristics of the evaluation indicators and the internal relation between the evaluation indicators are deeply dug out, various improvements are made to the calculation formula of the entropy weight of each evaluation indicator, and the comprehensive scores for the flood-control operation schemes are calculated based on the fuzzy set theory and the improved entropy weight method, thereby obtaining the training samples of the temporal convolutional network. According to the present disclosure, the calculation is simple, the logic is clear and easy to understand, which overcomes the disadvantages of traditional optimal-selection methods, which are that most of the traditional optimization methods only take a single reservoir as the research target, are highly subjective, are affected by the correlation of evaluation indicators, and require experts to assign the weights of different indicators. Besides, the weights will be changed with the flood-control situation, the time variation in the process of optimally selecting the flood-control operation scheme is fully considered, and the expected loss value that may be caused after the occurrence of risks at the reservoir or flood control point (water level or flow exceeds the safety threshold) is also fully considered in the effectiveness-risk decision indicators, thereby being capable of minimizing the risk of social and economic losses.

3. In the present disclosure, a supervised interpolation-based multi-sample data enhancement method (SMOTE) is adopted to expand the training samples of the temporal convolutional network to generate new samples for the small sample type, which effectively ensures the training precision of the temporal convolutional network. The use of the loss function that combines the mean square error and the Nash efficiency coefficient in training the temporal convolutional network, greatly improves the scientificity and rationality of the optimal selection of the flood-control operation scheme, and facilitates the coupling with the decision support system for flood-control operation of the reservoir so as to provide the decision-makers with the decision support, and to provide powerful tools for the comprehensive evaluation and optimal selection of the flood-control operation scheme for the group of the reservoirs.

### BRIEF DESCRIPTION OF THE DRAWINGS

FIG. 1 illustrates a flow chart of a method according to an embodiment of the present disclosure.

FIG. 2 illustrates a preferred model diagram of a flood-control operation scheme according to an embodiment of the present disclosure.

FIG. 3 illustrates a structural diagram of a temporal convolutional network according to an embodiment of the present disclosure.

FIG. 4 illustrates a diagram of a process for training the temporal convolutional network according to an embodiment of the present disclosure.

### DETAILED DESCRIP ON OF THE EMBODIMENTS

The evaluation indicators of the flood-control operation scheme in the reservoir is a set of a series of measurement dimensions that measure the pros and cons of the operation schemes from various target levels and various evaluation aspects, such as reservoirs, flood storages and detention areas, and hydrology stations. The scheme evaluation is essentially to use a certain mathematical model to integrate the indicator values into a comprehensive evaluation value, and to sort the schemes and select the optimal scheme according to the comprehensive evaluation value.

The facts found in the researches are that the existing researches on the evaluation of the flood-control operation schemes of reservoirs mainly focus on traditional evaluation methods and the improvements thereof, in which there is also great subjective arbitrariness in the selection of indicators, the impact of indicator correlations on the results of the comprehensive evaluation of the scheme is not considered, and experts are required to assign the weights to different indicators, which will not change with the flood control situation. Moreover, the existing researches are mostly directed to a single reservoir without considering the scenario of the flood-control operation for a group of reservoirs.

In order to optimally select the flood-control operation scheme more accurately, the problem of comprehensively evaluating the schemes seems to be more complicated, since it is necessary to select a second-level evaluation indicator for each first-level evaluation indicator for the reservoir group system, and the like. The eventually constructed indicator system is usually extremely huge, which increases the complexity of the modelling for selecting the optimal scheme. Therefore, for the optimal selection problem of the flood-control operation scheme for a large-scale group of reservoirs, the temporal convolutional network is used for optimally selecting the scheme in the present disclosure, which can greatly reduce the number of parameters in the complex model and better dig out the relationships between the evaluation indicators.

The present disclosure will be further described in detail below with reference to the accompanying drawings.

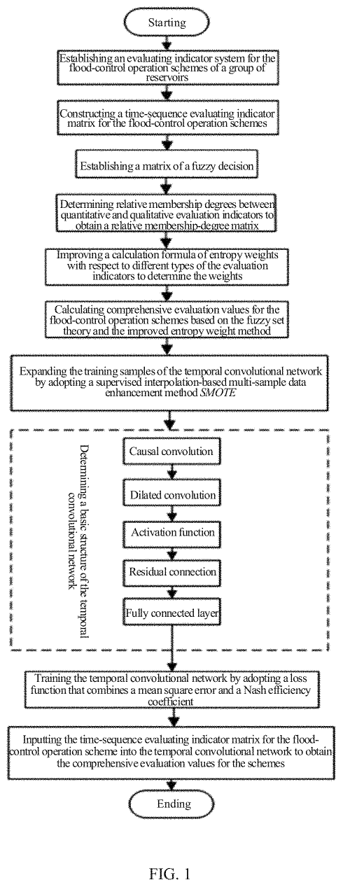

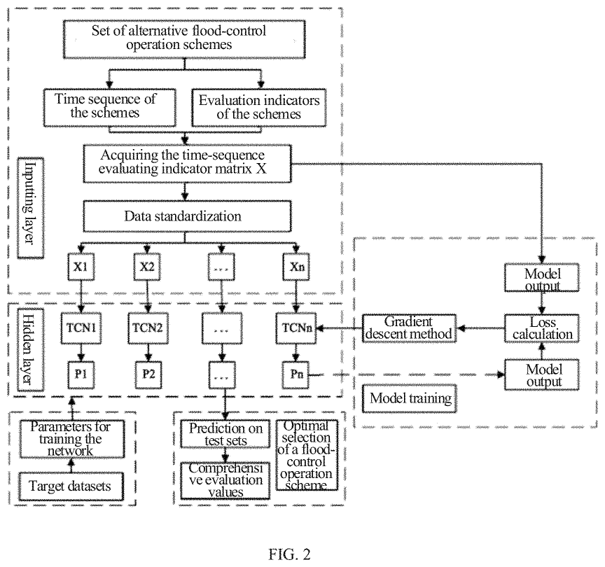

As illustrated in FIG. 1 and FIG. 2, provided is a method for optimally selecting a. flood-control operation scheme based on a temporal convolutional network according to the present disclosure. The method includes the following steps.

In Step 1, an evaluating indicator system for the flood-control operation schemes in a group of reservoirs is established.

The following principles should be complied to when establishing the evaluating indicator system for the flood-control operation: (1) objectivity, (2) independence, (3) systematicness, (4) operability, and (5) hierarchy. The number of evaluation indicators is less in the traditional method, and the correlation between the evaluation indicators is not considered. According to the above five principles and the disadvantages of the traditional methods, reservoirs, flood storage and detention areas, and hydrology stations are selected to serve as evaluation targets to establish the evaluating indicator system for the flood-control operation schemes, in comprehensive consideration of the risk and effectiveness of the flood-control operation schemes.

Step 1 specifically includes the following sub-steps.

In Step 1.1, the evaluating indicator system is Eᵢ={eᵢ₁, eᵢ₂, eᵢ₃, . . . , eᵢⱼ}, eᵢⱼ (i=1,2, . . . , n; j=1,2, . . . , m) is the value for the j-th evaluation indicator of the i-th scheme.

In Step 1.2, the evaluating indicator system for the flood-control operation for the group of the reservoirs is as follows.

| Evaluation | | Indicator |
|---|---|---|
| targets | Evaluation indicators | significances |
| Evaluation | The maximum flood | Effectiveness-oriented |
| indicators in | storage capacity | |
| the reservoirs | of each reservoir | |
| | Power generation | Effectiveness-oriented |
| | effectiveness | |
| | The maximum discharging | Cost-oriented |
| | flow of the reservoirs | |
| | Risk of exceeding | Cost-oriented |
| | the water level limit | |
| Evaluation | Guaranteed water level | Cost-oriented |
| indicators in the | Peak flow | Cost-oriented |
| hydrology stations | Time of exceeding the | Cost-oriented |
| | flow threshold | |
| | Risk of exceeding | Cost-oriented |
| | the flow limit | |
| Evaluation | Submerged duration | Cost-oriented |
| indicators in the | Submerged range | Cost-oriented |
| flood storages and | Economic loss | Cost-oriented |
| detention areas | Disaster-affected | Cost-oriented |
| | population | |

In Step 2, a time-sequence evaluating indicator matrix for the flood-control operation schemes is constructed, which serves as an input of the temporal convolutional network to calculate comprehensive scores for training samples of the flood-control operation schemes based on a fuzzy set theory and an improved entropy weight method.

The temporal convolutional network uses the convolutional network to solve the problem of time sequence data. For the optimal selection of the flood-control operation scheme for the reservoir, its main task is to enable the trained temporal convolutional network to make self-decision under time variation. Training samples of the network are generated based on the fuzzy set theory. The calculation formula of entropy weights is improved with respect to different evaluation indicators. The improved entropy weight method is used to set the weights of the evaluation indicators, so as to construct a time-sequence evaluating indicator matrix for the flood-control operation schemes, which serves as an input of the temporal convolutional network. The comprehensive evaluation values finally used to evaluate the pros and cons of the schemes serve as outputs. The comprehensive evaluation values are obtained by the fuzzy comprehensive evaluation method; Considering that the number of schemes generated in actual flood-control operation is generally finite, a supervised interpolation-based multi-sample data enhancement method (SMOTE) is used to expand the training samples of the temporal convolutional network to satisfy the requirements for the training precision of the neural network.

Step 2 specifically includes the following sub-steps.

In Step 2.1, a fuzzy decision matrix O=(oᵢⱼ)_{m×n} is established, where O represents a matrix of target eigenvalues for rn targets and n decision schemes, where i =1,2, . . . , n; j=1,2, . . . , m; oᵢⱼ is an eigenvalue for the target j in the scheme i. For the fuzzy comprehensive evaluation method, the objective is to determine the membership degree of each scheme to the fuzzy concept of “superiority”, and the scheme with the largest membership degree is the optimal scheme. Then, the relative membership degrees of the quantitative and qualitative evaluation indicators are determined. In order to eliminate the incommensurability caused by different dimensions and dimensional units, the absolute dimension of the evaluation indicators should be converted into the relative dimension, which is the relative membership degree. Generally, the relative membership of each indicator is a decimal within the interval of [0,1].

In Step 2.1.1, quantitative targets are standardized. The evaluation indicators involve two types of indicators, that is, the effectiveness-oriented (the greater the better) and the cost-oriented (the less the better). Different linear scale transformation methods are used corresponding to different types of evaluation indicators. The data indicators are normalized and standardized as follows:

for the effectiveness-oriented indicators:

$${r}_{ij} = \frac{{o}_{ij} - {o}_{jmin}}{{o}_{jmax} - {o}_{jmin}} \qquad \begin{matrix}i ∈ [ 1 , n ] & j ∈ [ 1 , m ] ,\end{matrix}$$

and

for the cost-oriented indicators:

$${r}_{ij} = \frac{{o}_{jmin} - {o}_{ij}}{{o}_{jmax} - {o}_{jmin}} \qquad i ∈ [ 1 , n ] \qquad j ∈ [ 1 , m ] ,$$

where oᵢⱼ is a value for the j-th evaluation indicator in the i-th scheme, and oⱼₘₐₓ and oⱼₘᵢₙ are the maximum value and the minimum value in the values for the j-th evaluation indicators in each scheme, respectively.

In Step 2.1.2, a bipolar ratio method is adopted to convert qualitative indicators into quantitative indicators. After the evaluation indicators are normalized and standardized, a relative membership-degree matrix R=(rᵢⱼ)_{m×n} of n schemes to m evaluation indicators is therewith determined, where rᵢⱼ(i=1,2, . . . , m; j=1,2, . . . , n) is the relative superiority membership degree for the j-th evaluation indicator in the i-th scheme.

In Step 2.2, for different evaluation indicators, the improved entropy weight method is respectively adopted to determine the weight set, and the weight vector of the evaluation indicators is W=(ω(1), 107 (2), . . . , ω(n)), Σᵢ₌₁ⁿω(i)=1 (i=1˜n).

In Step 2.2.1, the weights of evaluation indicators in reservoirs, flood storage and detention areas, and hydrology stations are set.

The evaluating indicator matrix X=(xᵢⱼ)_{l×q} is constructed, where l denotes the evaluation indicators, q denotes the evaluation targets, and i=1,2, . . . , q; j=1,2, . . . , l; xᵢⱼ is an eigenvalue of the indicator j of the target i.

After normalization, the relative superiority-membership-degree matrix R=(rᵢⱼ)_{l×q}∈[0,1] is obtained.

The entropy values for the evaluation indicators are calculated,

$${H}_{j} = \frac{1}{ln n} {\sum }_{i = 1}^{n} {e}_{ij} ln {e}_{ij} ,$$

where

$${e}_{ij} = \frac{{r}_{ij}}{{\sum }_{i = 1}^{n} {r}_{ij}} ,$$

j=1,2, . . . , m.

The entropy weights for the evaluation indicators are calculated, ωₕⱼ=Hₛωₕₛⱼ+(1−Hₛ)ωₕₖⱼ,

where

$${ω}_{hsj} = \frac{( 1 - {H}_{s} )}{{\sum }_{k = 1 , {H}_{k} \neq 1}^{m} ( 1 - {H}_{s} )} , {ω}_{hkj} = \frac{( 1 - {H}_{j} )}{{\sum }_{k = 1 , {H}_{k} \neq 1}^{m} ( 1 - {H}_{j} )} .$$

It should be noted that Hₛ is the same part, starting from a first digit after a decimal point, of the entropy values in an entropy value vector. Both of ωₕₛⱼ, ωₕₖⱼ are weight coefficients of entropy value separation magnitudes. rᵢⱼ is a relative superiority-membership-degree value of the indicator j of the target i. eᵢⱼ is a relative importance degree of rᵢⱼ.

In Step 2.2.2, the weights of risk-and-effectiveness evaluation indicators are set.

A risk-effectiveness negotiation decision model for the flood-control operation is constructed. It is assumed that the comprehensive risk-and-effectiveness evaluation indicators have a number of w+p, which include w risk evaluation indicators and p effectiveness evaluation indicators. A risk set DM1 and an effectiveness set DM2 are formed through systematic evaluation indicators, and u1(x) and u2(x) are defined as utility gain functions of risk and effectiveness:

$${u}_{1 j} ( x ) = {\sum }_{i = 1}^{w} {ω}_{i} \times {r}_{ji} , {u}_{2 j} ( x ) = {\sum }_{i = 1}^{p} {ω}_{i} \times {r}_{ji}$$

where ωᵢ is a weight of the risk or effectiveness evaluation indicator, and rⱼᵢ is a relative superiority-membership-delzree value of an evaluation indicators j of a target i.

Thus, a problem of multi-attribute decision-making optimization is transformed into a problem of nonlinear programming. For the utility gain functions, they are capable of forming a two-dimensional curved surface in a space. For risk-and-effectiveness constraint conditions, they are capable of forming a plane in the space. It can be known according to the utility gain functions and the risk-and-effectiveness constraint conditions that the target is to acquire a maximum value for the utility gain functions among the plane and curved surface nodes, which can be expressed as:

max{F(x)=[u₁(x), u₂(x)]}.

A risk weight of

$${ω}_{e} = \frac{{\sum }_{k = 1}^{l} {H}_{k} + 1}{{\sum }_{m = 1}^{l} ( {\sum }_{k = 1}^{l} 1 - 2 {H}_{k} )}$$

and an effectiveness weight of

$${ω}_{e}^{′} = \frac{{\sum }_{k = 1}^{l} 1 - 2 {H}_{k}}{{\sum }_{n = 1}^{l} ( {\sum }_{k = 1}^{l} {H}_{k} + 1 )}$$

are calculated, where i=1,2, . . . , l, Σᵢ₌₁^{l}ω=1, and Hₖ is an entropy value for the evaluation indicator j.

In Step 2,3, a fuzzy comprehensive evaluation is calculated.

A model for fuzzy comprehensive evaluation is bⱼ=Σᵢ₌₁^{m}ω(i) rᵢⱼ. The schemes are sorted according to a principle of maximum membership degree, and an optimal scheme, that is, Bₒₚₜ=max{bⱼ}, is selected from the flood-control operation schemes.

The training samples for temporal convolutional network are defined as {Y, bⱼ|Y=(x_{ab})_{t×12}}, where Y is the time-sequence evaluating indicator matrix for the flood-control operation schemes, and a, h are sequence numbers of time and evaluation indicators respectively.

In Step 2.4, the training samples of the temporal convolutional network are expanded by adopting a supervised interpolation-based multi-sample data enhancement method MOTE) to generate new samples in the small sample type.

In Step 2.4.1, an eigenspace is defined. Each sample is mapped to a certain point in the eigenspace, and a sampling ratio N is determined according to a sample imbalance ratio,

In Step 2.4.2, K nearest neighbor samples are found according to an Euclidean distance for each sample (x, y) in the small sample type, and a sample point is randomly selected from the K nearest neighbor samples. It is assumed that the selected nearest neighbor point is (xₙ, yₙ), a point from a line segment between the sample point and the nearest neighbor sample point in the elgenspace is randomly selected as a new sample point, which satisfies the following formula:

(x_{new}, y_{new})=(x, y)+rand(0−1)*((xₙ−x), (yₙ−y)).

In Step 2.4,3, the above steps are repeated until the numbers of large and small samples are balanced.

In Step 3, a structure of the temporal convolutional network is determined. The structure includes an inputting layer, a causal dilated convolution, an activation function, a residual connection, a fully connected layer and an outputting layer.

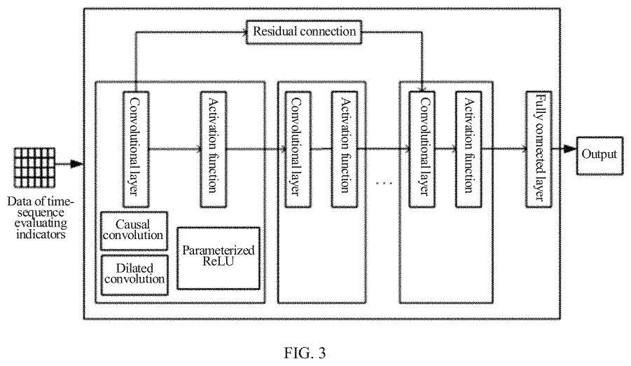

With reference to FIG. 3. Step 3 specifically includes the following steps.

In Step 3.1, the causal convolution.

The causal convolution is used in the temporal convolutional network to process the input data so as to calculate and extract the feature information of the underlying data. At any time t, a single convolution operation with a convolution kernel size of 3 is performed, where a filter is F=(f₁, f₂, . . . , fₖ), and a sequence is X=(x₁, x₂, . . . , xₜ). The causal convolution process at the position of xₜ can be expressed as (F*X) (x ₜ)=Σₖ₋₁^{K}fₖx_{t-k+K}.

In Step 3.2, dilated convolutions.

Dilated convolutions in different sizes are set. The dilation factor d represents the distance between the two elements of the convolution kernel. Firstly, the convolution kernel size is expanded, and then the elements of the expanded part of the convolution kernel are set to 0. The convolution kernel size is set to 3, and the expansion factors to 1, 2, and 4 sequentially. The filter is F=(f₁, f₂, . . . , fₖ), the sequence is X=(x₁, x₂, . . . , xₜ), the expansion factor is d, and the expansion convolution process at the position of xₜ can be expressed as (F*_{d} X) (Xₜ)=Σₖ₌₁^{K}fₖx_{t-(K-k)d}.

In Step 3.3, the parameterized ReLU is used as the activation function.

The activation function can perform nonlinear operations on the extracted features to increase the fitting ability of the network. The gradient of the ReLU function is 1 when x≥0 and 0 when x<0, in which it is difficult to train when encountering a convolution kernel smaller than 0. In order to solve the above detects, a parameterized ReLU function is used as the activation function:

ReLU(x)=max{ax, x}, 0<a<1.

For the parameter a as a learnable variable in the network model, an optimal value thereof can be automatically obtained in the overall training process of the network model.

In Step 3.4, a residual connection.

There are two dilated causal convolutional layers and activation functions respectively on the residual line. 6 residual blocks are set to be stacked, the dilation factors of which from left to right ranges from 20 to 25, and the baseline of each residual block is connected to the output of the last residual block through jump connections and tensors are added, which facilitates the identity learning for the network after any residual block, and mitigates the problem of network degradation to the greatest extent. The residual block contains two nonlinear transformation branches (F₁, F₂), and the output of the residual blocks can be regarded as a linear operation of the residual output F₁ and the baseline output F₂:

o=F₁(x)+F₂(x).

In Step 3.5, a fully connected layer.

The output of the last residual block is connected to the fully connected layer with a sigmoid activation function. The calculation formula from the fully connected layer to the output is:

SOCₖ^{*}=σ(wₒᵤₜhₖ+bₒᵤₜ).

where wₒᵤₜ, bₒᵤₜ represent the weight matrix and bias, respectively, hₖ is a hidden output tensor of the last residual block at the time step length k, and σ represents the sigmoid function.

In Step 4, the temporal convolutional network is trained by adopting a loss function that combines a mean square error and a Nash efficiency coefficient.

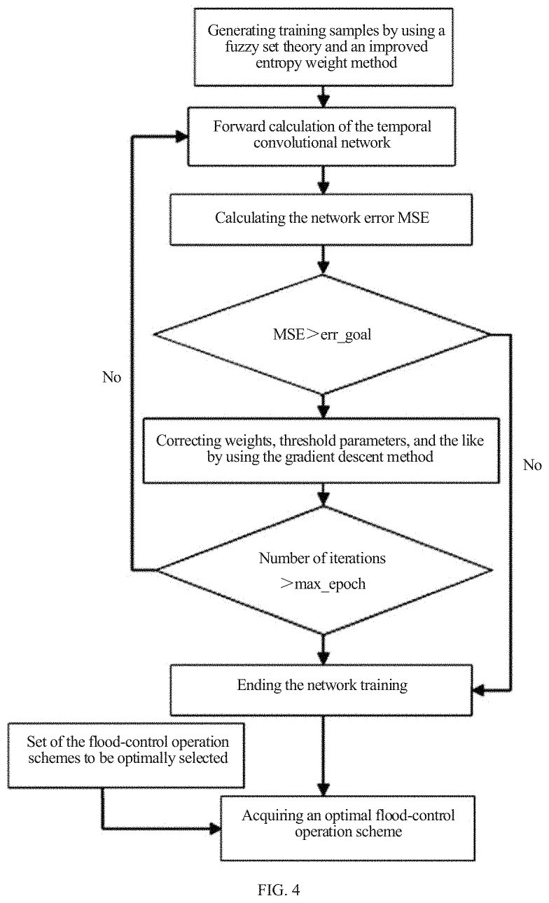

With reference to FIG. 4, Step 4 specifically includes the following steps.

In Step 4.1, the training data are selected by randomly sampling, and the network training samples are used for network training and network validating, respectively with a ratio of 80% and 20%. The learning and training of the temporal convolutional network includes a forward propagation phase and a backward propagation phase.

In Step 4.2, in the forward propagation phase, all filters and parameters/weights are initialized with random numbers. The time-sequence evaluating target matrix for the flood-control operation schemes that combines the comprehensive evaluation indicators and the time sequence is input, and then the output values are obtained by the forward propagation sequentially passing through the causal dilated convolution, the activation function, the residual connection, and the fully connected layer.

In Step 4.3, in the backward propagation phase, a loss function MSE′ that combines the mean square error and the Nash efficiency coefficient is constructed, which is used to train the temporal convolutional network to obtain the error between the output value and the target value of the network.

The loss function can be expressed as MSE′(y, y′),

$${MSE}^{′} ( y , {y}^{′} ) = \frac{{\sum }_{i = 1}^{n} {α ( {y}_{i} - {y}_{{i}^{′}} )}^{2}}{n} , α = 1 - \frac{{\sum }_{t = 1}^{T} {( {y}_{i} - {y}_{{i}^{′}} )}^{2}}{{\sum }_{t = 1}^{T} {( {y}_{i} - \overline{{y}_{i}} )}^{2}} ,$$

where yᵢ is an output value for the sample i, yᵢ′ is a target value for the sample i, y̅ᵢ is an average value for the output value of the sample i, α is a Nash correction parameter, and T is a time.

According to the obtained error, the gradient descent method is adopted to update all of the values for filters; weights and parameters to minimize the output error. When the number of training iterations satisfies the requirements and the error is less than or equal to the expected values, the training is ended, and the temporal convolutional network reach the convergence.

In Step 5, the time-sequence evaluating indicator matrix for the flood-control operation schemes is input into the temporal convolutional network to obtain the comprehensive evaluation values for the schemes, and an optimal comprehensive evaluation value is taken as an optimal flood-control operation scheme for the group of reservoirs.

In summary, in the method for optimally selecting the flood-control operation scheme based on the temporal convolutional network according to the present disclosure, the number of parameters in the complex models can be greatly reduced, the relationships between the evaluation indicators can be better dug out, and the process of optimally selecting the optimal flood-control operation scheme, fully considered under time variation, can improve the evaluation performance of the optimal selection of the model by using fine-tuning techniques adequately based on the idea of transfer learning.

1. A method for optimally selecting a flood-control operation scheme based on a temporal convolutional network, wherein the method comprises the following steps:
Step 1, establishing an evaluating indicator system for flood-control operation schemes of a group of reservoirs;
Step 2, constructing a time-sequence evaluating indicator matrix for the flood-control operation schemes, wherein the matrix serves as an input of the temporal convolutional network, calculating comprehensive scores for training samples of the flood-control operation schemes based on a fuzzy set theory and an improved entropy weight method: establishing a fuzzy decision matrix, determining relative membership degrees between quantitative evaluation indicators and qualitative evaluation indicators to obtain a matrix of the relative membership degrees, thereby constructing the time-sequence evaluating indicator matrix for the flood-control operation schemes; taking the matrix as the input of the temporal convolutional network, and improving a calculation formula of entropy weights with respect to different types of the evaluation indicators; calculating the comprehensive evaluation values for the flood-control operation schemes based on the fuzzy set theory and the improved entropy weight method, and taking the comprehensive evaluation values used to eventually determine pros and cons of the schemes as outputs, wherein the comprehensive evaluation values are obtained by a fuzzy comprehensive evaluation method; expanding the training samples of the temporal convolutional network by adopting a supervised interpolation-based multi-sample data enhancement method SMOTE to generate new samples for small sample types;
Step 3, determining a structure of the temporal convolutional network, including an inputting layer, a causal dilated convolution, an activation function, a residual connection, a fully connected layer and an outputting layer;
Step 4, training the temporal convolutional network by adopting a loss function that combines a mean square error and a Nash efficiency coefficient; and
Step 5, inputting the time-sequence evaluating indicator matrix for the flood-control operation schemes into the temporal convolutional network to obtain the comprehensive evaluation values for the schemes, and taking an optimal comprehensive evaluation value as an optimal flood-control operation scheme for the group of reservoirs.

2. The method for optimally selecting the flood-control operation scheme based on the temporal convolutional network according to claim 1, wherein S2 specifically comprises the following steps:
Step 2.1, setting weights of the evaluation indicators of reservoirs, flood storage and detention areas, and hydrology stations;
Step 2.1.1, normalizing the evaluating indicator matrix X=(xᵢⱼ)_{l×q} to obtain a relative superiority-membership-degree matrix R=(rᵢⱼ)_{l×q}, rᵢⱼ∈[0,1];
where l represents evaluation indicators, q represents evaluation targets, i=1,2, . . . , q; j=1,2, . . . , l; and xᵢⱼ is an eigenvalue of an indicator j of a target i;
Step 2.1.2, calculating entropy weights ωₕⱼ of the evaluation indicators;
ωₕⱼ=Hₛωₕₛⱼ+(1−Hₛ)ωₕₖⱼ
where both ωₕₛⱼ and ωₕₖⱼ are weight coefficients of entropy value separation magnitudes, Hₛ is a same part, starting from a first digit after a decimal point, of entropy values in an entropy value vector, rᵢⱼ is a relative superiority-membership-degree value of the indicator j of the target i, Hⱼ is an entropy value corresponding to rᵢⱼ, and eᵢⱼ is a relative importance degree of rᵢⱼ,
$${ω}_{hsj} = \frac{( 1 - {H}_{s} )}{{\sum }_{k = 1 , {H}_{k} \neq 1}^{m} ( 1 - {H}_{s} )} , {ω}_{hkj} = \frac{( 1 - {H}_{j} )}{{\sum }_{k = 1 , {H}_{k} \neq 1}^{m} ( 1 - {H}_{j} )} , \\ {H}_{j} = \frac{1}{ln n} {\sum }_{i = 1}^{n} {e}_{ij} ln {e}_{ij} , {e}_{ij} = \frac{{r}_{ij}}{{\sum }_{i = 1}^{n} {r}_{ij}} , j = 1 , 2 , … , m ;$$
Step 2.2, setting weights of risk-and-effectiveness evaluation indicators;
Step 2.2.1, constructing a risk-effectiveness negotiation decision model for the flood-control operation;
assuming that the comprehensive risk-and-effectiveness evaluation indicators have a number of w+p, which comprises w risk evaluation indicators, and p effectiveness evaluation indicators, forming a risk set DM1 and an effectiveness set DM2 through systematic evaluation indicators, and defining u1(x) and u2(x) as utility gain functions of the risk and the effectiveness, the utility gain functions are as follows:
$${u}_{1 j} ( x ) = {\sum }_{i = 1}^{w} {ω}_{i} \times {r}_{ji} , {u}_{2 j} ( x ) = {\sum }_{i = 1}^{p} {ω}_{i} \times {r}_{ji}$$
where ωᵢ is a weight of a risk or effectiveness evaluation indicator, and rⱼᵢ is a relative superiority-membership-degree value of a target i of an evaluation indicator j;
wherein a problem of multi-attribute decision optimization is thus transformed into a problem of nonlinear programming; for the utility gain functions, they are capable of forming a two-dimensional curved surface in a space; for risk-and-effectiveness constraint conditions, they are capable of forming a plane in the space; it is known according to the utility gain function and the risk-and-effectiveness constraint conditions that the target is to acquire a maximum value for the utility gain functions among the plane and curved surface nodes, which is expressed as:
max{F(x)=[u₁(x), u₂(x)]}
Step 2.2.2, calculating the risk-and-effectiveness weights; where
a weight of a risk indicator is
$${ω}_{e} = \frac{{\sum }_{k = 1}^{l} {H}_{k} + 1}{{\sum }_{m = 1}^{l} ( {\sum }_{k = 1}^{l} 1 - 2 {H}_{k} )} ,$$
and
a weight of an effectiveness indicator is
$${ω}_{e}^{′} = \frac{{\sum }_{k = 1}^{l} 1 - 2 {H}_{k}}{{\sum }_{n = 1}^{l} ( {\sum }_{k = 1}^{l} {H}_{k} + 1 )}$$
where i=1,2, . . . , l, Σᵢ₌₁^{l}ω=1, and Hₖ is an entropy value for an evaluation indicator j;
Step 2.3, performing a calculation of fuzzy comprehensive evaluation;
wherein a model for the fuzzy comprehensive evaluation is bⱼ=Σᵢ₌₁^{m}ω(i) rᵢⱼ, the schemes are sorted according to a principle of maximum membership degree, an optimal scheme is selected from the flood-control operation scheme, that is, Bₒₚₜ=max{bⱼ}; and the training samples for the temporal convolutional network are expressed as {Y, bⱼ|Y=(x_{ab})_{t×12}};
wherein Y is the time-sequence evaluating indicator matrix for the flood-control operation schemes, and a, b are sequence numbers of time and evaluation indicators respectively; and
Step 2.4, defining an eigenspace, mapping each sample to a certain point in the eigenspace, and determining a sampling ratio N according to a sample imbalance ratio; finding, for each sample (x, y) in a small sample type, K nearest neighbor samples according to an Euclidean distance, and randomly selecting a sample point from the K nearest neighbor samples, randomly selecting, assuming that the selected neighbor point is (xₙ, yₙ), a point from a line segment between the sample point and the nearest neighbor sample point in the eigenspace as a new sample point, which satisfies a following formula:
(x_{new}, y_{new})=(x, y)+rand(0−1)*((xₙ−x), (yₙ−y)), and
repeating the above steps until numbers of large and small samples are balanced.

3. The method for optimally selecting the flood-control operation scheme based on the temporal convolutional network according to claim 1, wherein Step 3 comprises the following steps:
setting a convolution kernel size of the causal convolution to be 3; setting a convolution kernel size of the dilated convolution to be 3 as well, where dilation factors are 1, 2, and 4 sequentially; and adopting a parameterized ReLU=max{ax, x} as an activation function, where 0<a<1; wherein two dilated causal convolution layers and two activation functions are present on a residual line respectively, 6 residual blocks are set to be stacked on the residual line, the dilation factors of the residual blocks from left to right are from 20 to 25; and an output of a last residual block is connected to a fully connected layer with a sigmoid activation function.

4. The method for optimally selecting the flood-control operation scheme based on the temporal convolutional network according to claim 1, wherein Step 4 further comprises the following steps:
constructing a loss function MSE′ that combines the mean square error and the Nash efficiency coefficient, and training, by adopting MSE′, the temporal convolutional network, which is expressed as:
$${MSE}^{′} ( y , {y}^{′} ) = \frac{{\sum }_{i = 1}^{n} {α ( {y}_{i} - {y}_{i}^{′} )}^{2}}{n} , α = 1 - \frac{{\sum }_{t = 1}^{T} {( {y}_{i} - {y}_{i}^{′} )}^{2}}{{\sum }_{t = 1}^{T} {( {y}_{i} - \overline{{y}_{i}} )}^{2}}$$
where yᵢ is an output value for a sample i, yᵢ′ is a target value for the sample i, y̅ₗ is an average value of output values for the sample i, α is a Nash correction parameter, and T is a time; and
updating values of the weights and the parameters by a gradient descent method according to an obtained error to minimize an output error, and ending, when a number of training iterations satisfies requirements and the error is less than or equal to an expected value, the training.
